(19) United States
(12) Patent Application Publication
(10) Pub. No.: US 2024/0203058 A1
(43) Pub. Date: Jun. 20, 2024

(54) SYSTEM AND METHOD FOR PERFORMANCE IN A VIRTUAL REALITY ENVIRONMENT

(71) Applicant: QUILL & QUAVER ASSOCIATES PTY. LTD., Malvern East, Victoria (AU)

(72) Inventor: Kevin John PURCELL, Malvern East (AU)

(73) Assignee: QUILL & QUAVER ASSOCIATES PTY. LTD., Malvern East, Victoria (AU)

(21) Appl. No.: 18/287,395

(22) PCT Filed: Aug. 24, 2021
(86) PCT No.: PCT/AU2021/050944

§ 371 Date: Oct. 18, 2023

(30) Foreign Application Priority Data
Apr. 20, 2021 (AU) 2021901171

(51) Int. Cl. G06T 19/00; A63F 13/63; A63F 13/814; A63F 13/86; G06F 3/01; G06F 16/41

(52) U.S. Cl. CPC G06T 19/00; A63F 13/63; G06F 3/011; G06F 16/41; A63F 13/814; A63F 13/86; A63F 2300/8082; G06T 2219/024

(57) ABSTRACT

The disclosure relates to a virtual reality system for a virtual performance and includes an immersive virtual reality environment defined by a performance framework and includes pre-defined visual data and pre-defined audio data. At least one user input device and at least one user output device is provided for a user in electronic communication with the immersive virtual reality environment. The user interacts with the immersive virtual reality environment and inserts into the system, user visual data and/or user audio data that is created within the performance framework by the user during immersion in the virtual reality environment.

### CROSS-REFERENCE TO RELATED APPLICATIONS

This application is a national phase entry of PCT Patent Application Serial No. PCT/AU2021/050944 filed on Aug. 24, 2021, which claims priority to the Australian Patent Application Serial No. 2021901171 filed on Apr. 20, 2021, both of which are incorporated by reference herein.

### TECHNICAL FIELD

The present invention relates to the field of virtual reality performance. In one form, the present invention relates to the field of interactive entertainment of the type known as virtual reality and more particularly to interactive entertainment involving computer image and audio generation and control.

In another form, the invention relates to electronic video and live performance entertainment. More specifically the present invention relates to entertainment and performance arts whereby participants interact with an electronic or computerised environment. Even more specifically the present invention relates to virtual reality computer systems in which participants interact with a virtual reality environment and performance using a variety of immersion and input devices such as a head mounted display and handheld input device. It will be convenient to hereinafter describe the invention in relation to musical plays, however it should be appreciated that the present invention is not limited to that use only and is intended to include all forms of performance art including dramatic performance and musical performance.

### BACKGROUND

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Virtual reality is a computer simulated experience that mimics the real world or can create an alternative reality. It allows participants to experience things that do not exist through computers that create a believable, interactive 3D world. As the participant moves around, the virtual reality world moves with them. To be both believable and interactive, virtual reality needs to engage both the mind and body of the participant.

Virtual reality has been applied to an enormous range of experiences including entertainment (i.e. video games) and education, vocational training (i.e. medical or military training), architecture and urban design, digital marketing and activism, engineering and robotics, fine arts, healthcare and clinical therapies, heritage and archaeology, occupational safety, social science and psychology. For example, well known examples of VR for entertainment and gaming include the Wii Remote, the Kinect, and the PlayStation all of which track and relay player movement to the game. Many devices provide an augmented experience using controllers or haptic feedback. VR-specific and VR versions of popular video games have been released.

Virtual reality can allow individuals to virtually attend concerts, even using feedback from the user's heartbeat and brainwaves to enhance the experience. Virtual reality can be used for other forms of music, such as music videos and music visualization or visual music applications.

The virtual reality experience requires (a) a richly detailed virtual world to experience and explore, in the form of a computer simulation, (b) a powerful computer that can detect where the user is going and adjust their experience in real time, and (c) hardware linked to the computer that fully immerses the user in the virtual world as they move around and explore. Virtual reality hardware includes sensors that detect how and where the user's body is moving, a headset having two screens (one for each eye), stereo or surround sound speakers. Alternatively, virtual environments can be created through specially designed rooms with multiple large screens. Some form of auditory feedback, visual feedback, or sensory feedback may best be provided through haptic technology. The user can look around the virtual environment, have the sensation of moving within the environment, and interact with virtual features.

The term ‘immersive virtual reality environment’ typically refers to a computer-generated graphical environment where a participant is “immersed” within the environment so as to provide to the user an illusory sensation of being physically located within the graphical environment, although the participant is in reality only electronically present with the other objects in the environment. It is interactive in the sense that the user responds to what they see, and what they see responds to the user. For example, if the user changes their perspective by turning their head, what they see and hear changes to match the new perspective.

The participant is represented in the software environment by projections of figures called avatars. Participants control their avatars using input mechanisms such as hand-held input devices and data generated from electronic and electromagnetic tracking devices that monitor body movement. Passive or active objects which are not controlled by the participant are generally controlled by a computer software program and move in a predetermined manner within the virtual reality environment but may respond to the input of the participant.

In the past, the immersive virtual reality environment for artistic performances has been relatively constrained. For example, U.S. Pat. No. 6,409,599 to Virtual Immersion Technologies LLC describes a virtual reality environment in which a performance is viewed through VR head mounted display devices. The participants can view an immersive graphical environment of live or pre-recorded performers, but their participation only extends limited control over the content and outcome of the performance through manual input devices

There is therefore a need for participants to be able to have a higher degree of immersion in the virtual reality environment so that they can more fully participate in an artistic performance as a spectator or as a performer.

### SUMMARY

An object of the present invention is to provide a virtual reality experience in the context of an immersive, interactive performance. A further object of the embodiments described herein to overcome or alleviate at least one of the above noted drawbacks of related art systems or to at least provide a useful alternative to related art systems.

In its broadest aspect the present invention provides a virtual reality system for a virtual performance including:
an immersive virtual reality environment defined by a performance framework and comprising pre-defined visual data and pre-defined audio data, and
at least one user input device and at least one user output device for a user in electronic communication with said immersive virtual reality environment,
wherein said user interacts with said immersive virtual reality environment to insert into the system, user visual data or user audio data created within the performance framework by the user during immersion in the virtual reality environment.

In a preferred embodiment the user visual data or user audio data created by the user during immersion in the virtual reality environment is inserted into a database for software that runs the virtual reality system. The inserted user visual data or user audio data may add data to the database, or alternatively replace at least some of the data in the database.

### Performance Framework

The virtual performance may be, for example, a dramatic play, musical play, dance routine, choral piece, concert or ceremony not physically existing as such but made to appear to do so by data run on software. The performance framework is the basic structure underlying the actions that comprise the performance.

The performance framework may include multiple sub-frameworks. The sub-frameworks could be principal divisions of a performance such as the acts of a play, scenes of a musical, or movements of a concerto. The sub-frameworks could also be relatively small actions, such as individual dances, sound tracks, songs or speeches of a script that can be embodied in audio data or visual data. In one embodiment of the present invention, the performance framework includes a pre-determined number of optional sub-frameworks that can be chosen by the user to perform or watch in the virtual reality environment.

### Visual Data

Visual data comprises data relating to displays that are received by eye, typically using a VR headset and the visual parts of a performance that can be uploaded to the virtual reality environment. Visual data may include, for example, instructions to a user wearing a VR headset, such as words that should be spoken or sung at specific times, and indications of body poses and positions that the user should adopt at specified times. The body poses and positions may be displayed as a semitransparent “ghost” with which the performer can align their body, foot marks indicating where the performer should stand, or a series of foot marks indicating dance steps. For users who are spectators rather than performers, the visual data may prompt them to clap, cheer or otherwise participate in the performance.

The “pre-defined visual data” of the present invention typically guides the user through the performance. For example, the user as performer may be guided in their own creation of visual data in terms of where to move or what pose to assume during the performance. The user as spectator may be guided by the pre-defined visual data in terms of where to look, or when to sing, or when to clap. Visual data may also comprise part of a performance recorded by a user, co-performances by other users, or pre-recorded for a user to view during immersion in the virtual reality environment.

### Audio Data

Audio data comprises data relating to sounds that are received by ear during immersion in the virtual reality environment, typically through an audio device such as headphones, and the audible parts of a performance that can be uploaded to the virtual reality environment. Audio data may include, for example, pre-recorded sounds for a user wearing headphones, such as musical accompaniment, background effects or dialogue.

The pre-defined audio data of the present invention typically guides the user through the performance. For example, the user as performer may be guided in their own creation of audio data in terms of what to say, sing or play, or the pre-defined audio data may direct them where to move or what pose to assume. The user as spectator may be guided by the pre-defined audio data in terms of where to look, or when to sing along, or when to clap. Audio data may also comprise part of a performance recorded by a user or pre-recorded for a user to hear during immersion in the virtual reality environment.

### User

A user may interact with said immersive virtual reality environment as a performer or a spectator. Typically, a spectator will have a relatively passive interaction with the immersive virtual reality environment inserting audio data or visual data (such as emojis) indicating feelings, or opinions, such as approval or disapproval. Typically, a performer will have a relatively active interaction with the immersive virtual reality environment, inserting visual data and/or audio data of a performance. The visual data or audio data may replace or be created in response to audio data or visual data presented to the user in the virtual reality environment.

In one embodiment, a user can take on the persona of a character within a performance framework, such as a musical play and customise their appearance. In the persona of the character, the user can then record movement as visual performance data, or record music or dialogue as audio data. The recorded audio or visual data can be added to the database used by the software running the virtual reality musical play.

In another embodiment, the user can have the recorded audio or visual data replace pre-recorded audio or visual data in the database used by the software running the virtual reality musical play. For example, the user can replace pre-recorded audio data to alter the voice of a character in the virtual reality environment of a musical play. For example, the user could mute the character's singing, or spoken voice (pre-recorded audio data) and substitute their own singing (audio data) effectively becoming the singing voice of the musical character in performance.

In a particularly preferred embodiment, the user interacts with the immersive virtual reality environment to replace pre-recorded visual data or pre-recorded audio data associated with one or more performance components with visual performance data and/or audio performance data created by the performer during immersion in the virtual reality environment. For example, the performer can input new or replacement audio data in the form of dialogue or music-related performance associated with the virtual reality environment of a musical by audio remixing and uploading new or alternative lyrics or dialogue data.

### Multiple Users

In another embodiment, the system of the present invention is adapted for interaction with two or more users (multiple users) in a ‘multi-user’ environment, subsequently or simultaneously in respect of the same immersive virtual reality environment defined by the same performance framework. The multiple users may all be performers, or all be spectators, or comprise a mixture of performers and spectators. The user may, for example, join a virtual cast of other users who are in one or more locations, each user able to perform their avatar as a ‘virtual cast member’ of a musical play. For example, each user's avatar may sing a vocal part of the musical's songs and speak a corresponding script.

Preferably, each user can receive information from the virtual reality system about other users in performance. The information may be, for example, skeleton data or points cloud information, that depicts each user's position and pose. In all such instances, regardless of the number of performers inhabiting character roles within the musical play, the avatar corresponding to each performer remains visible to all other performers, but not to the person performing the respective character role, i.e., the performer becomes the embodiment of the character avatar.

In another embodiment, the user can add or substitute audio data of any instrumental track of a musical accompaniment into the virtual reality environment. For example, the user may mute the audio data of a single instrument track of an orchestrated musical score and take on the instrumental performance. In this manner the user could, for example, become a member of an orchestra in the virtual reality musical environment. Alternatively, the user can join a virtual reality orchestra environment comprising other users located in one or more locations. Each user can contribute audio data embodying their own performance of an orchestral part to create a ‘virtual orchestra’. For example, each user may contribute audio data of an instrumental part of the orchestral score of the musical.

### Gaming Component

As mentioned above, the performance may be, for example, a dramatic play, musical play, dance routine, concert or ceremony. The performance framework defines the parameters of the performance such as the duration, the timing and occurrence of logical divisions within the performance. In a further embodiment, the performance framework includes a gaming component.

For example, during a dramatic play or musical play, the narrative may include a gaming component in the form of an event such as a horse race or similar sporting event, challenge, quest or puzzle that is typically embodied in a computer game. The user as a performer or as a spectator may participate in the event. The gaming component may be contiguous to the performance and, for example, comprise a separate software routine that is called and executed within the dramatic flow of the story experience being interacted with. It may be optional to pass over the gaming component without dislocation to the narrative being followed yet the gaming component can still remain integral to the experience. It will be readily apparent that the genre of the gaming component is not critical, and any appropriate game can be created integral to the experience.

### Further Aspects

In a second aspect of the invention described herein the system further comprises:
at least one processing device;
at least one system database;
a network;
said network connecting said processing device and said user input device and said user output device in electronic communication.

The input device may include, for example, a hand-held keypad, microphone, video camera or other device for recording audio data or visual data. The output device may include, for example, a display screen, a speaker, headphones, VR headset and sensors, such as haptics.

In a third aspect of the invention described herein there is provided a method for interaction between a user and an immersive virtual reality environment, the method including:
providing an immersive virtual reality environment defined by a performance framework and comprising pre-recorded visual data and pre-recorded audio data relating to performance components, and
providing at least one user input device and at least one user output device in electronic communication with said immersive virtual reality environment, the method including the step of said user communicating with said immersive virtual reality environment to insert visual performance data or pre-recorded audio performance data created by the user, preferably during immersion in the virtual reality environment.

Performance components may include any aspect of audio data or visual data that is comprised in the performance. For example, for a musical play, components would include part, or all, of a script, an instrumental performance or a visual performance. In a preferred embodiment the method includes the step of said user communicating with said immersive virtual reality environment to replace pre-recorded visual data or pre-recorded audio data created by the performer, preferably during immersion in the virtual reality environment. For example, the user may create and record many versions of a performance component before choosing the best version to replace all others.

In a fourth aspect of embodiments described herein there is provided a non-transitory computer readable storage medium having a computer program stored therein, wherein the program, when executed by a processor of a computer, causes the computer to execute the method comprising the aforementioned method steps for interaction between a user and an immersive virtual reality environment. In a fifth aspect of embodiments described herein there is provided an application stored on a non-transitory medium adapted to functionally enable said application comprising a predetermined instruction set adapted to enable the aforementioned method steps for interaction between a performer and an immersive virtual reality environment. Other aspects and preferred forms are disclosed in the specification and/or defined in the appended claims, forming a part of the description of the invention.

In essence, embodiments of the present invention stem from the realisation that it is possible for a users' contribution can be added to extant media to be incorporated into the virtual reality system playback, irrespective of whether this is across a local or shared network server. Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1A_is a flow chart illustrating the high-level system architecture for the present invention as a whole, in the context of a musical play as the performance framework. Subsequent figures (FIG. 1B to FIG. 1F) illustrate parts of the system architecture in greater detail;

FIG. 1B is a flow chart illustrating the high-level system architecture of the lobby as further illustrated in detail in FIGS. 2A to 2K;

FIG. 1C is a flow chart illustrating the user customising a character as further illustrated in detail in FIGS. 3A to 3F;

FIG. 1D is a flow chart illustrating the user joining the performance as a spectator as further illustrated in detail in FIGS. 4A to 4C;

FIG. 1E is a flow chart illustrating the user rehearsing their performance as further illustrated in detail in FIGS. 5A to 5D; and

FIG. 1F is a flow chart illustrating the user's live performance as further illustrated in detail in FIGS. 6A to 6E.

FIGS. 2A to 2K are flow charts illustrating in detail the software steps relating to the portion of the flow chart in FIG. 1A and FIG. 1B that is designated as the lobby. This is where the user selects a performance to watch, a performance to join as a performer or selects a performance to practice;

FIGS. 3A to 3F are flow charts illustrating in detail the software steps relating to the portions of the flow chart in FIG. 1A and FIG. 1C that relate to the user customising the character;

FIGS. 4A to 4C are flow charts illustrating in detail the software steps relating to the portion of the flow chart in FIG. 1A and FIG. 1D that relate to a user joining the performance as a spectator;

FIGS. 5A to 5D are flow charts illustrating in detail the software steps relating to the portion of the flow chart in FIG. 1A and FIG. 1E that is designated as the acting studio. This is where the user can rehearse their performance;

FIGS. 6A to 6E are flow charts illustrating in detail the software steps relating to the portion of the flow chart in FIG. 1A and FIG. 1F for joining a performance as a performer. This is where the user performs live, with an audience, or pre-records without an audience.

### DETAILED DESCRIPTION

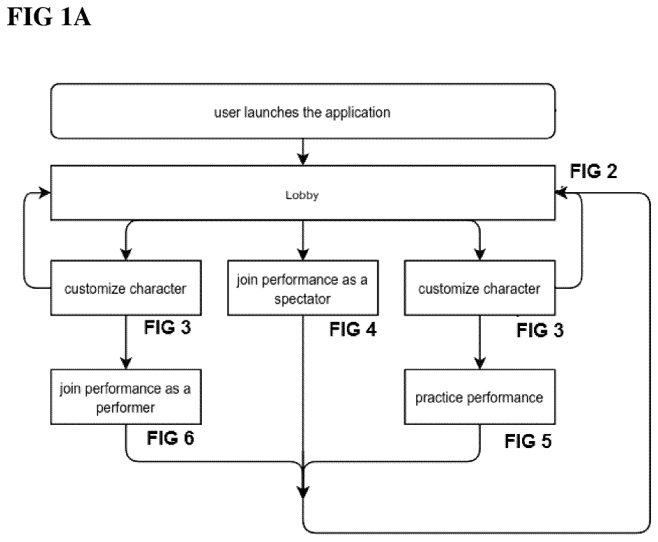

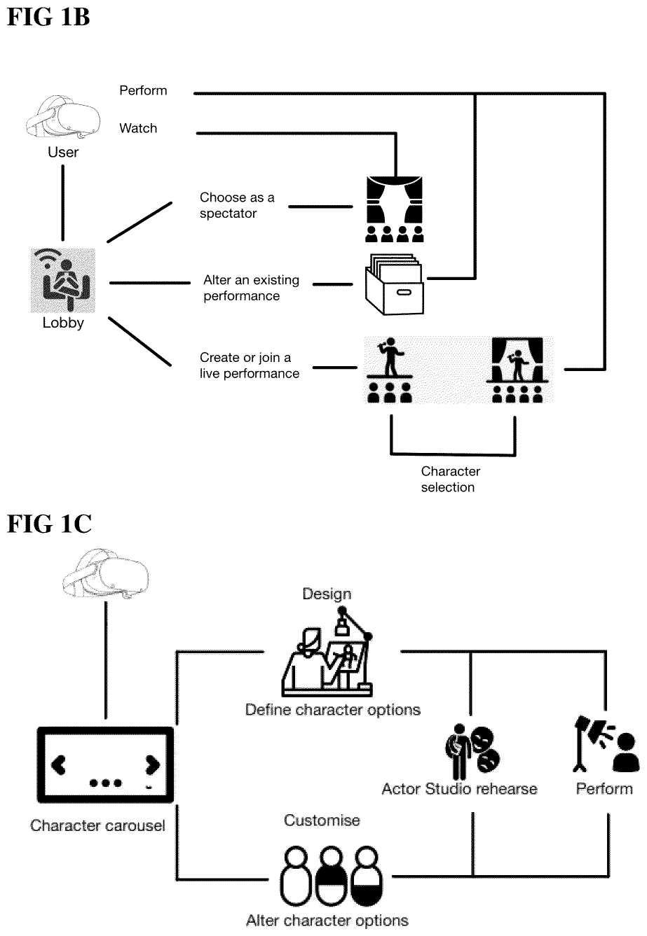

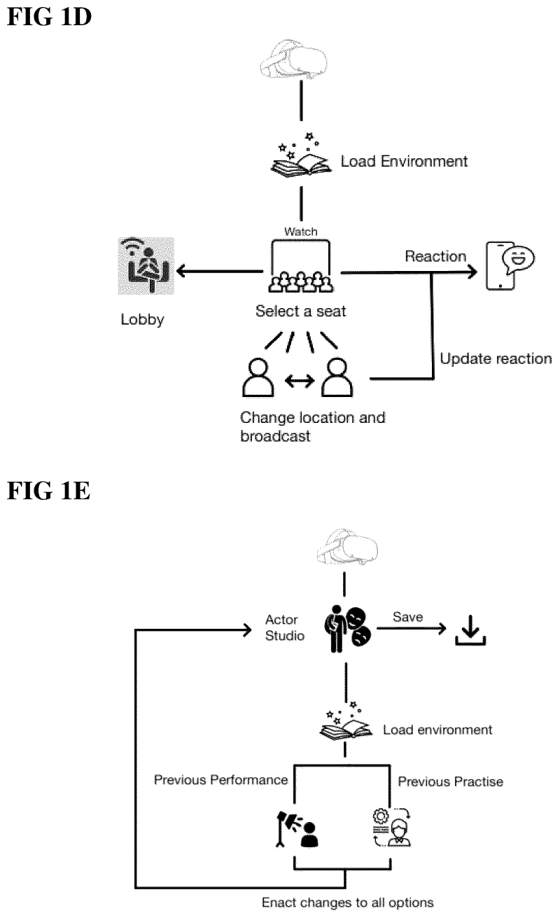

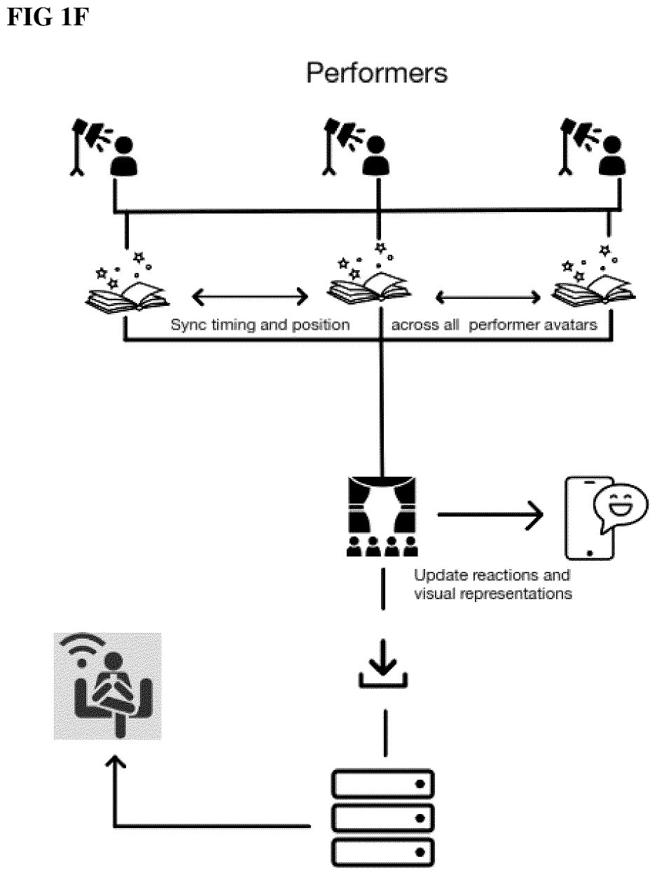

The present invention thus provides a system by which a user can interact with an immersive virtual reality environment in the context of a performance framework such as a musical play, dramatic play, or other type of performance. FIG. 1 is a series of flow charts illustrating the high-level system architecture for the present invention, in the context of a musical play as the performance framework. Subsequent figures (FIG. 1A to FIG. 1F) illustrate parts of the system architecture in greater detail.

The performer can communicate with the immersive virtual reality environment to insert visual performance data and/or audio performance data created by the performer. The data inserted may replace an existing performance component such as a song, an entire soundtrack, or a visual performance by a character.

Typically, the user inserts the performance data during immersion in the virtual reality environment. For example, the user may take on the persona of an avatar to add a character as a new performance element in the virtual reality environment, or they may replace an existing character. In all such instances, regardless of the number of performers inhabiting character roles within the musical play, the avatar corresponding to each performer remains visible to all other performers, but not to the person performing the respective character role, that is, the performer becomes the embodiment of the character avatar.

### Lobby

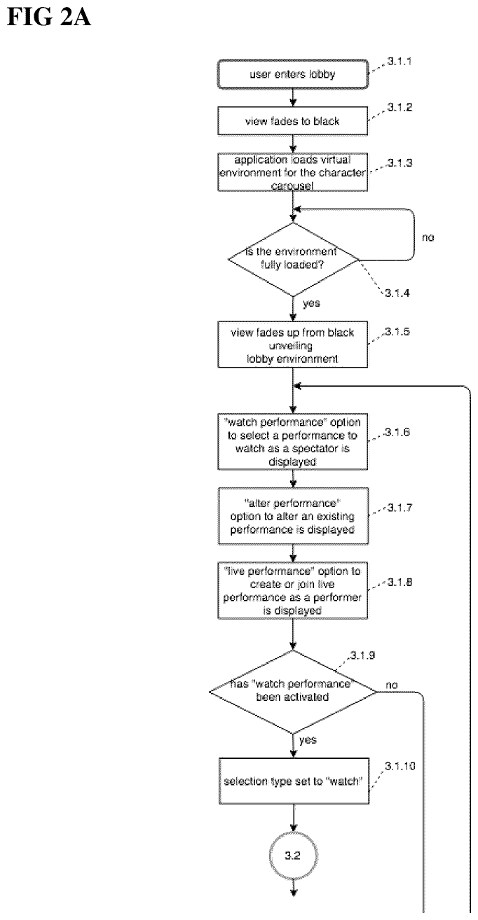

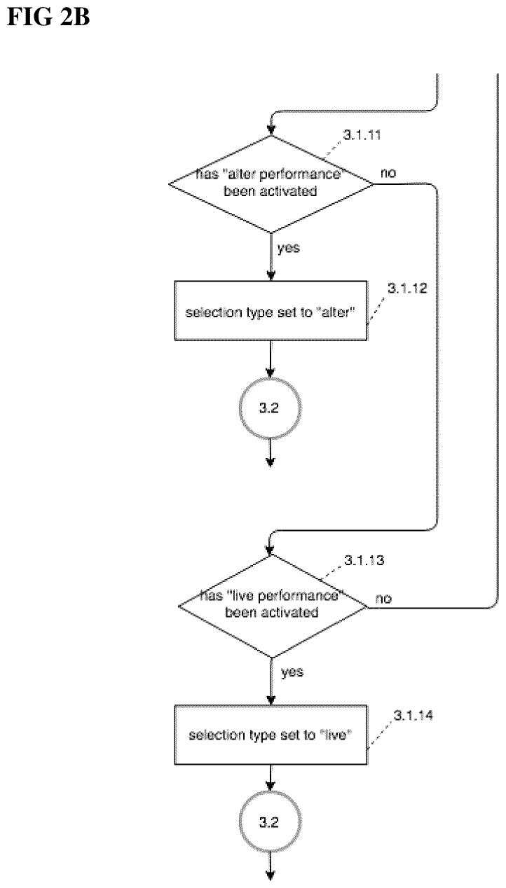

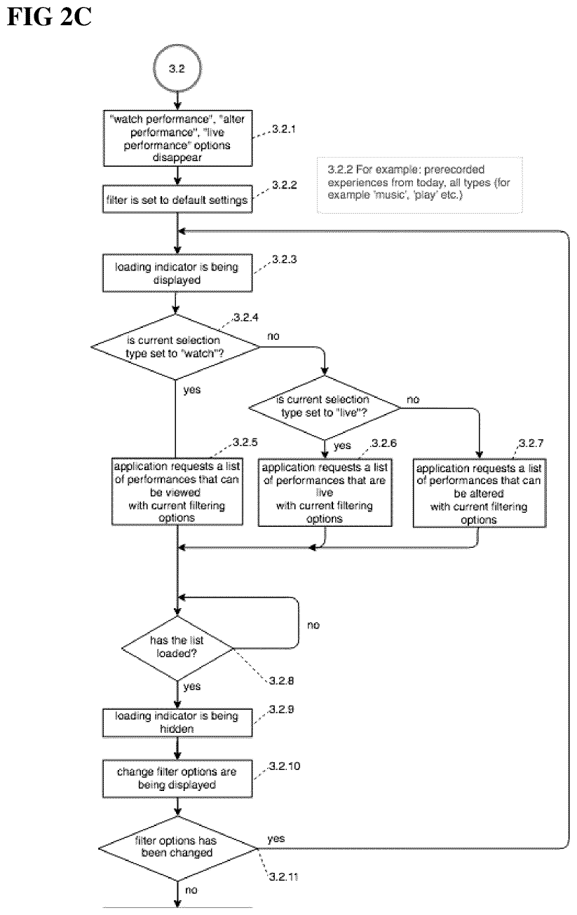

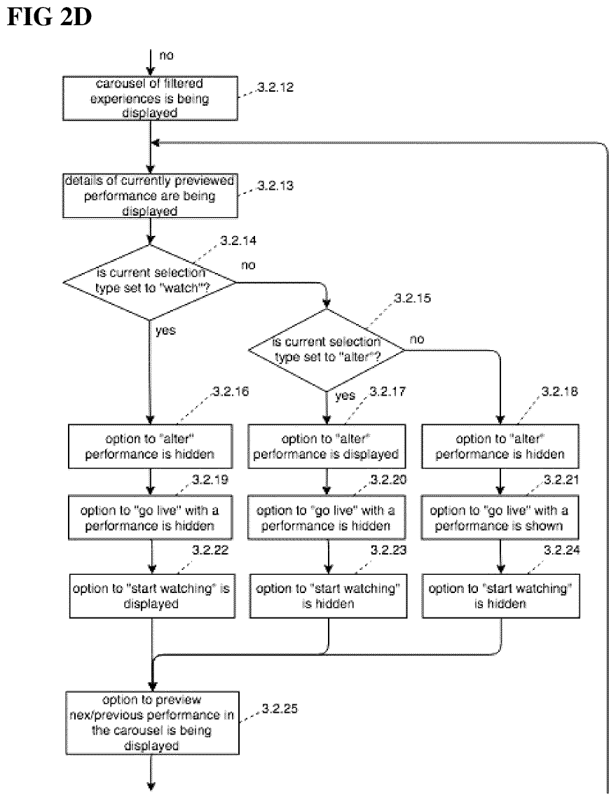

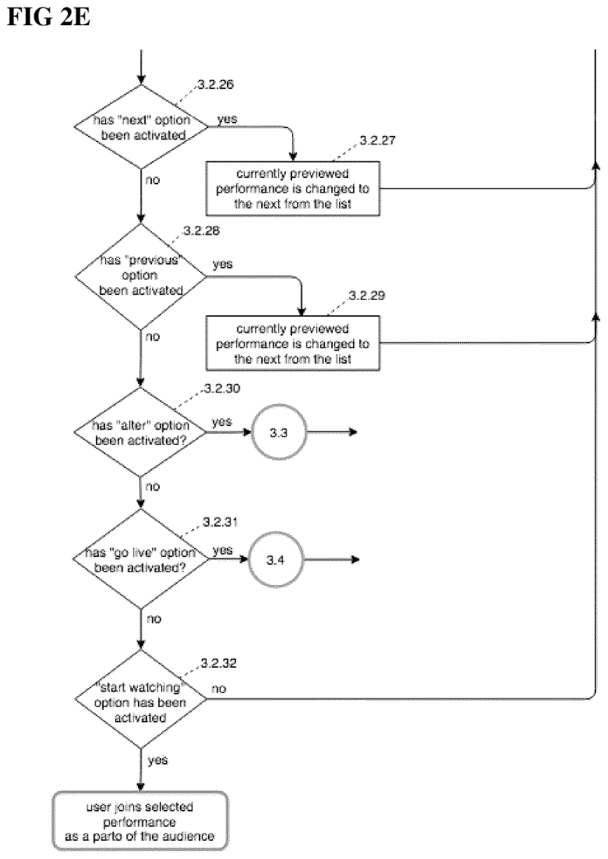

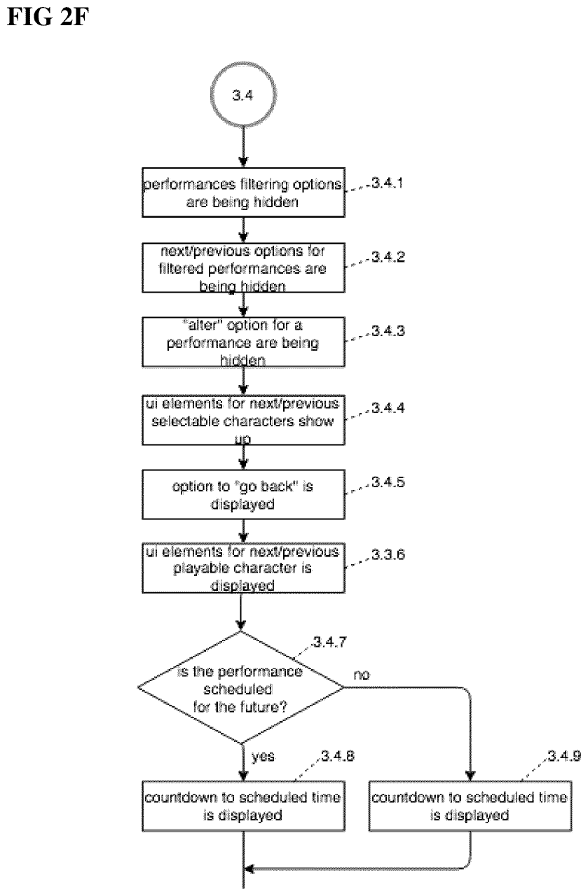

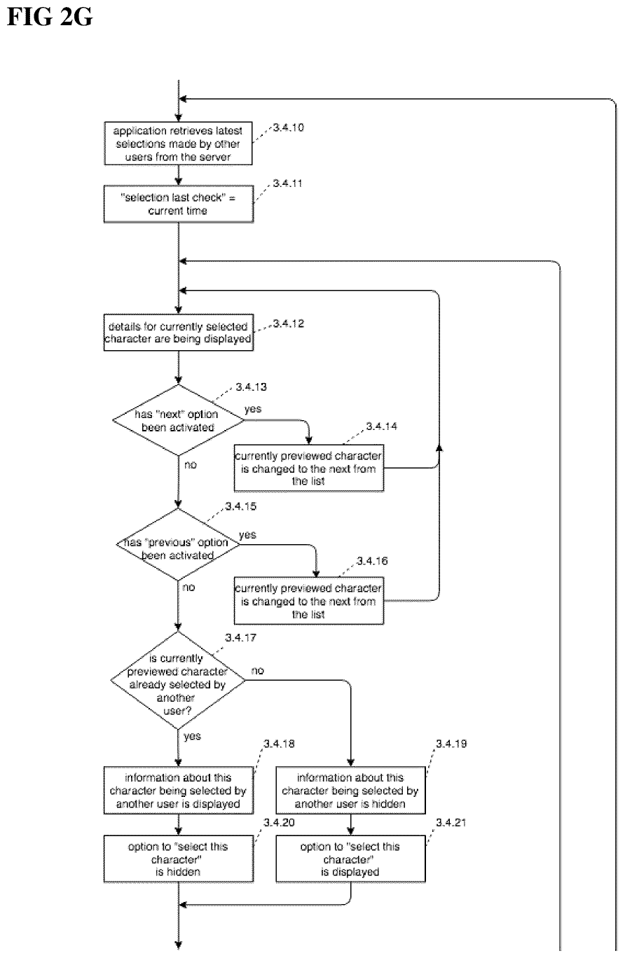

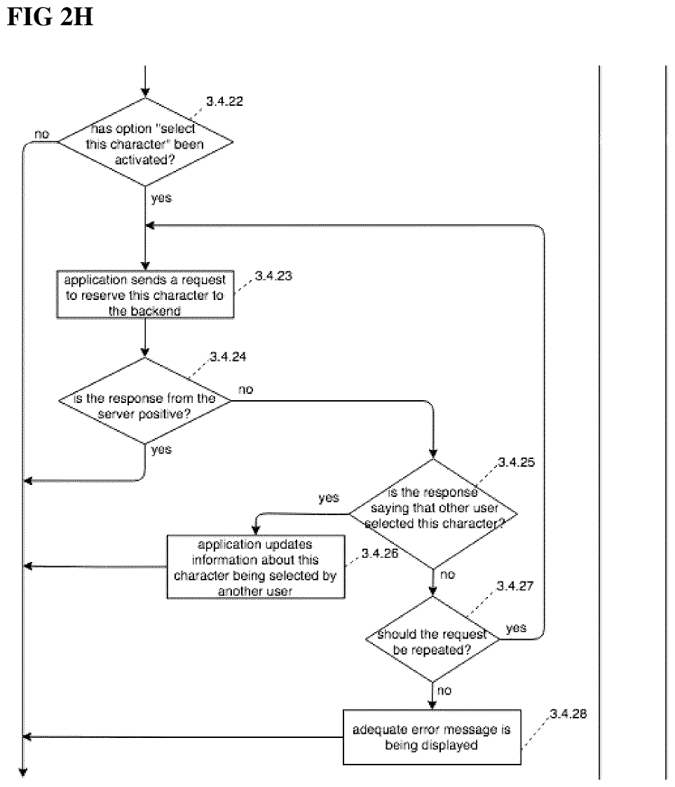

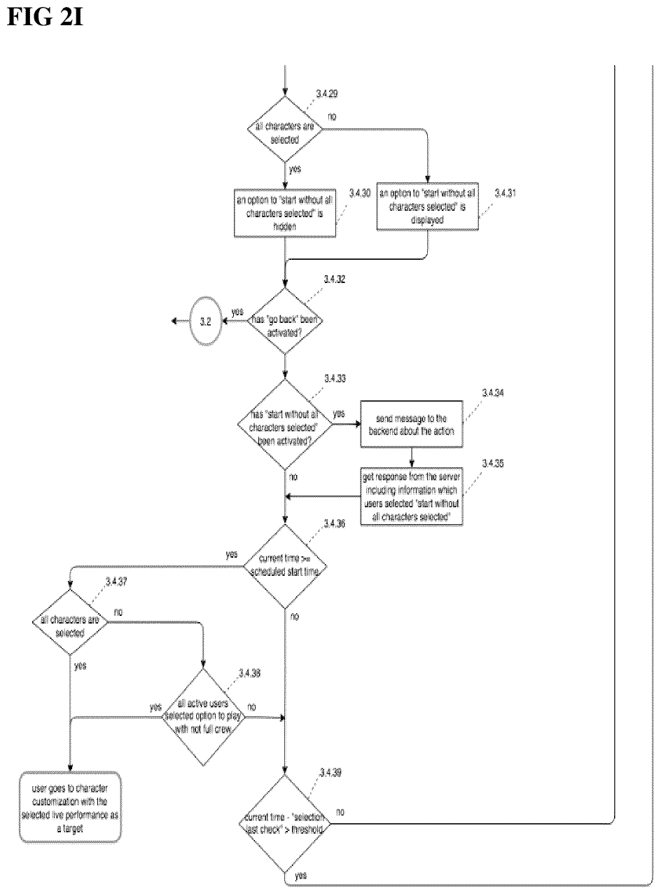

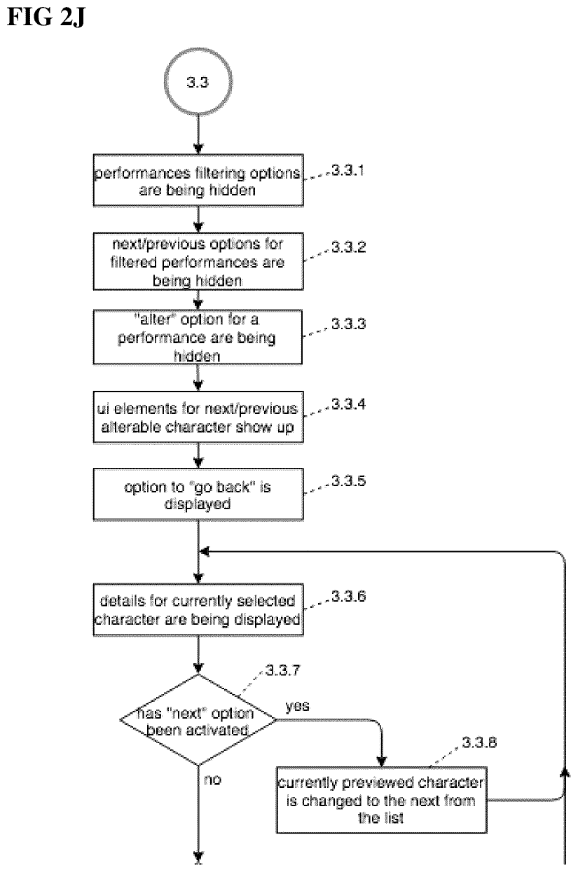

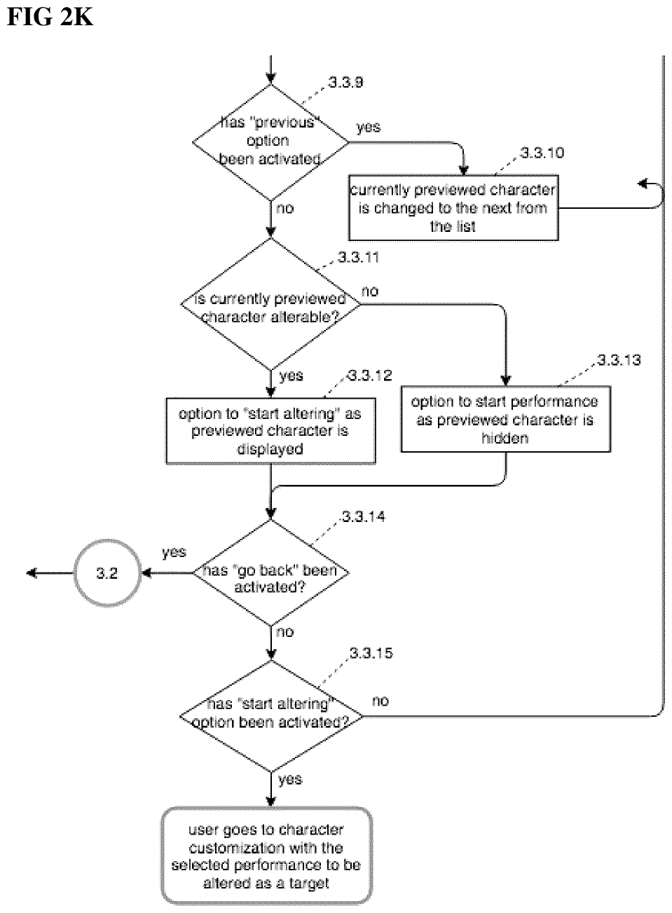

FIGS. 2A to 2K comprises flow charts illustrating in detail the software steps relating to the lobby. The lobby is the ‘main menu’ or ‘dashboard’ of the experience. Here the user can choose to watch a performance as a spectator, edit a pre-existing performance, rehearse for an upcoming performance in the acting studio, or set-up a live performance.

The user, having entered the lobby has three options:
3.1.6—the “watch performance” option to select a performance to watch solely as a spectator. The performances are either live or recorded in the past.
3.1.7—the “alter performance” option to select a performance that was recorded in the past and saved with an option allowing them to be altered. This means that the user can replace any part of the performance to make their own variation of the performance.
3.1.8—the “live performance” option to create a new, live performance with a live audience, or join a live performance at its scheduled starting time.

Once the user has made their initial choices, they are provided with a corresponding list of performances (3.2.5, 3.2.6, 3.2.7)—the performance frameworks that they can watch, alter or perform live. Details from the backend include a list of performance frameworks with their descriptions, parameters (e.g., running time etc.), whether live or prerecorded and whether it can be altered.

The filter options can then be changed (3.2.10). Filtering options may include, for example, date, whether live or prerecorded, type of performance (e.g. musical, play, music performance), keyword, and other filtering options.

The user may proceed to watch and become a spectator in the performance framework as a spectator. Alternatively, the user proceeds to character customisation in preparation for on their way to participating as a performer or altering an existing performance framework.

### Character Selection and Customisation

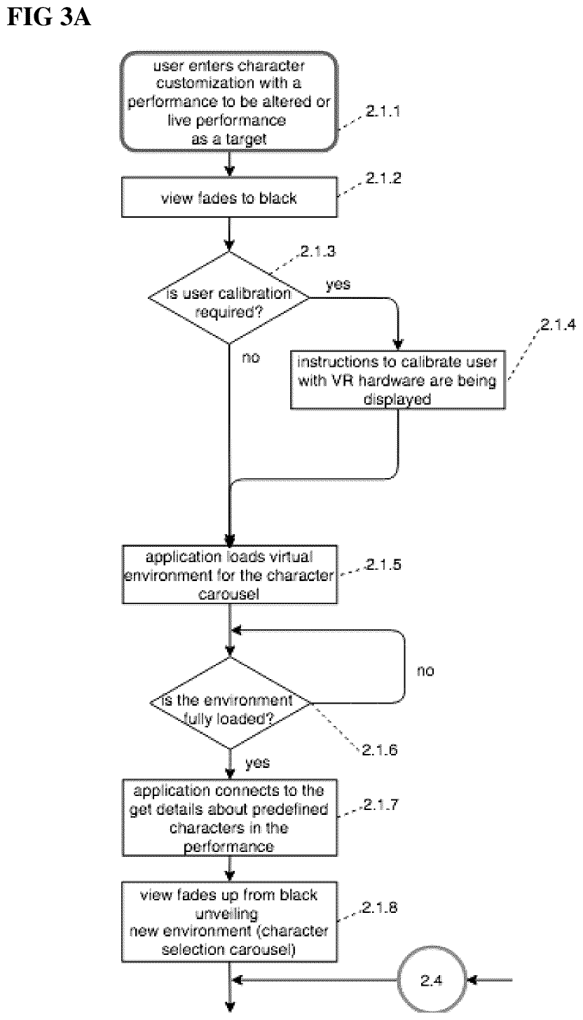

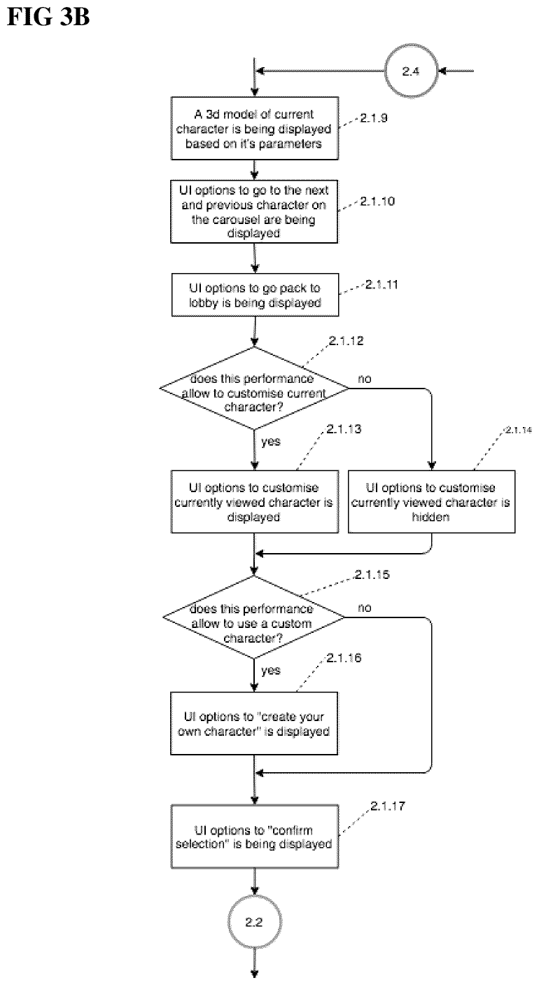

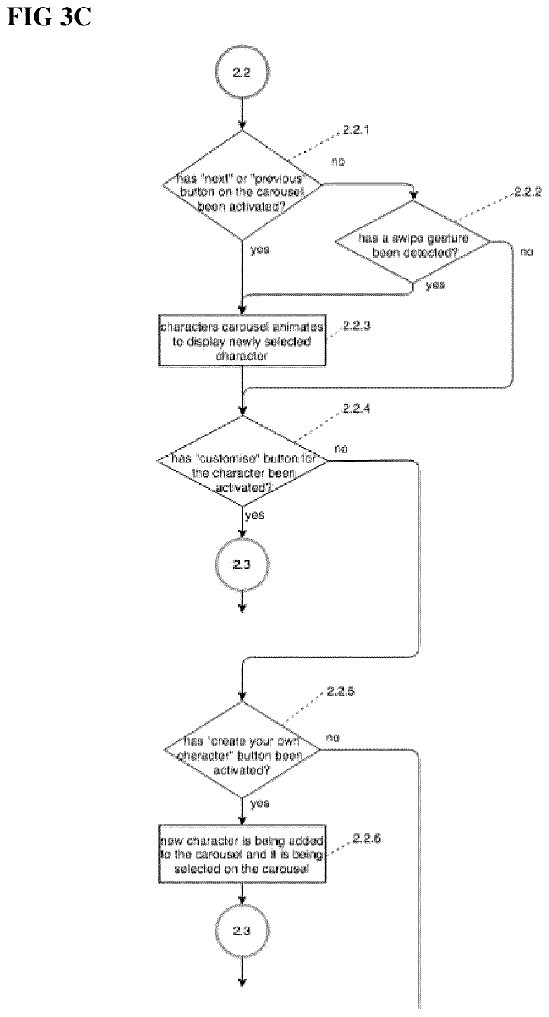

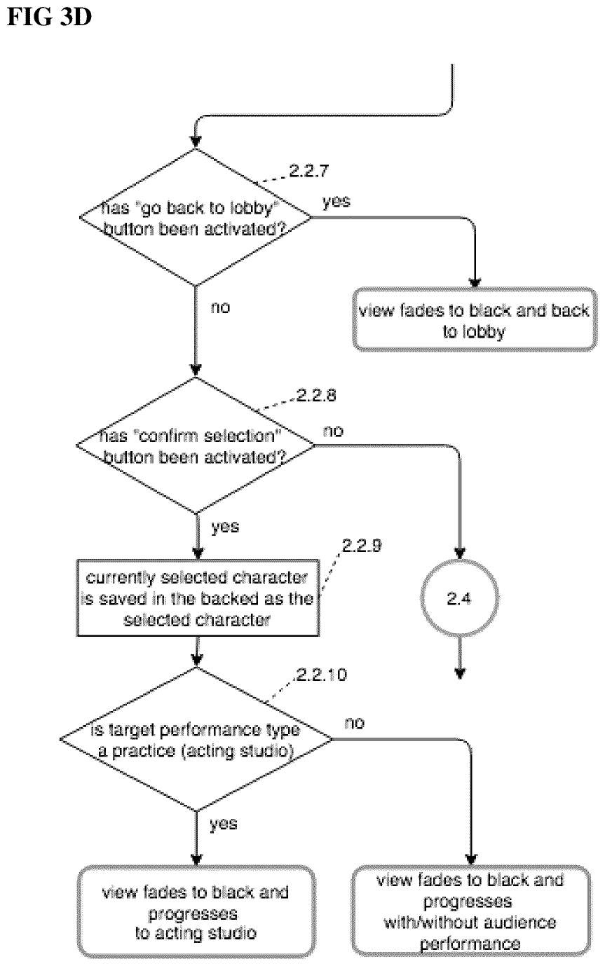

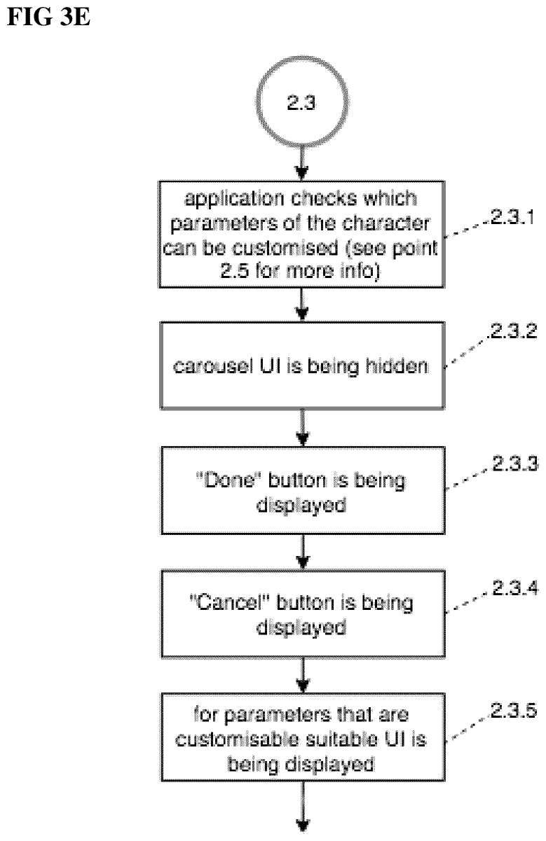

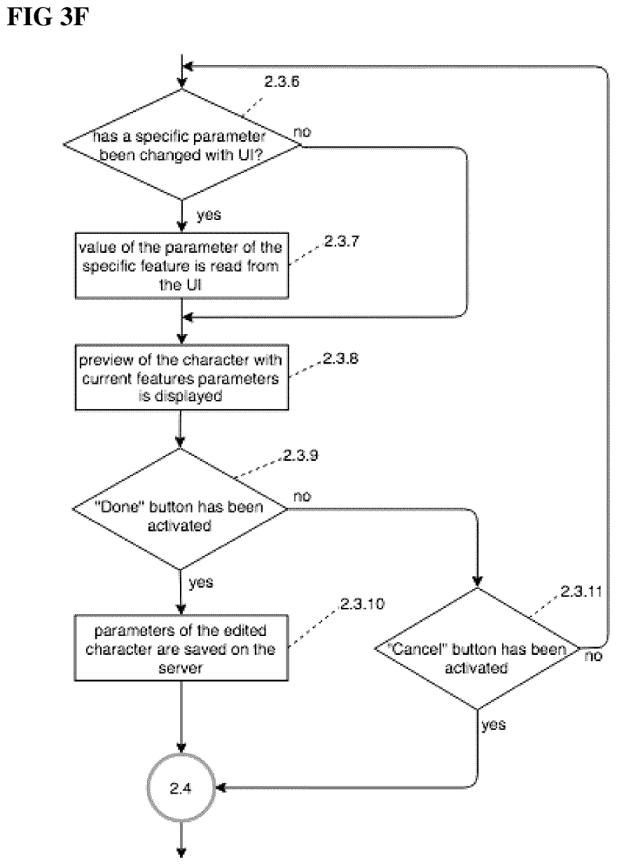

FIGS. 3A to 3F comprises flow charts illustrating in detail the software steps relating to the user customising the character they will embody within the performance framework. In the character selection and customisation screen the user chooses the character. These have been pre-programmed to suit whichever performance the application is running. For example, if the performance framework embodies Les Miserables a character selection carousel would show pre-designed 3D avatars of characters in that musical (e.g., Jean Valjean, Javert, Cosette). The user can then customise these characters using sliders. The attributes that can be customised may include for example, hair colour, shoe style or eye colour.

Each performance framework may have associated with predefined characters (2.1.7). For example, if the performance framework embodies the play “Romeo and Juliet” play the characters would include Romeo, Juliet, Mercutio, Tybalt, Friar Laurence, Benvolio and Capulet. Each of those characters needs to be created when the performance is added to the backend database of the system of the present invention. Parameters describing the characters' visual representations are stored in the backend database and are retrieved in this step. (2.1.7) Character parameters in the backend database include information as to whether a character can be customised and if so, which of the features of the character can be customised (for example, hair colour may be changed but the clothing cannot.).

A 3D model of a character animates in an idle way (2.1.9). When used in this context the term “current” as applied to a character means a currently selected character to be previewed in a carousel. The options for variation may vary per character hence the option may be visible only for some of them. (2.1.12, 2.1.13) The user may be creating the character to inhabit in the performance framework (with or without an audience), or it can be created for use in the acting studio. (2.2.10)

### User as a Spectator of the Performance

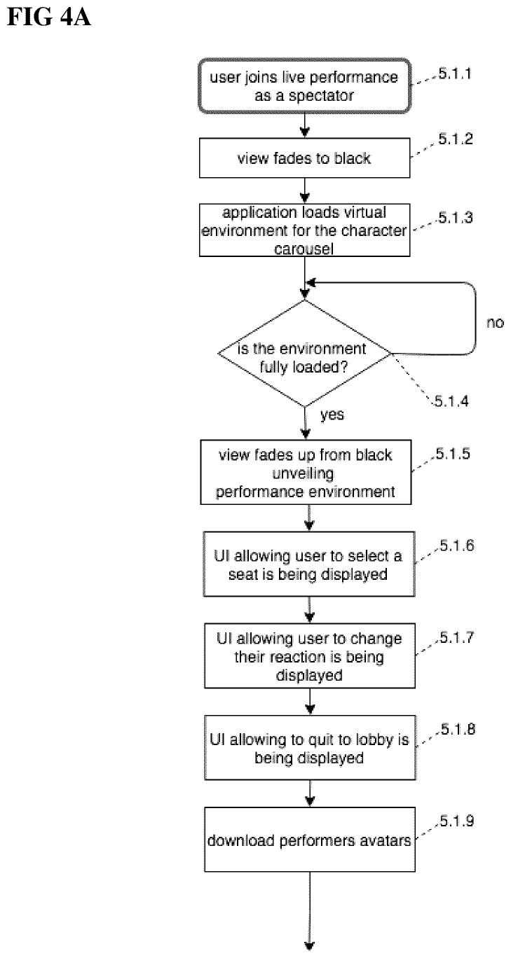

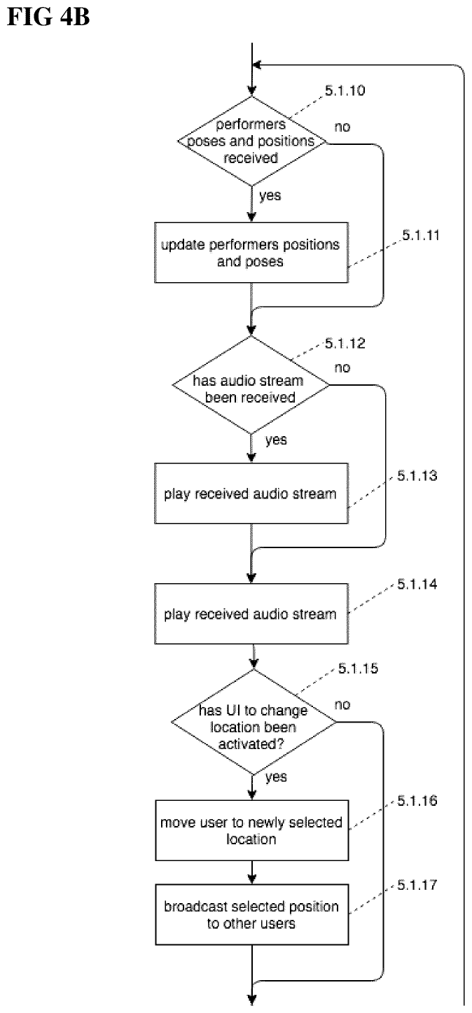

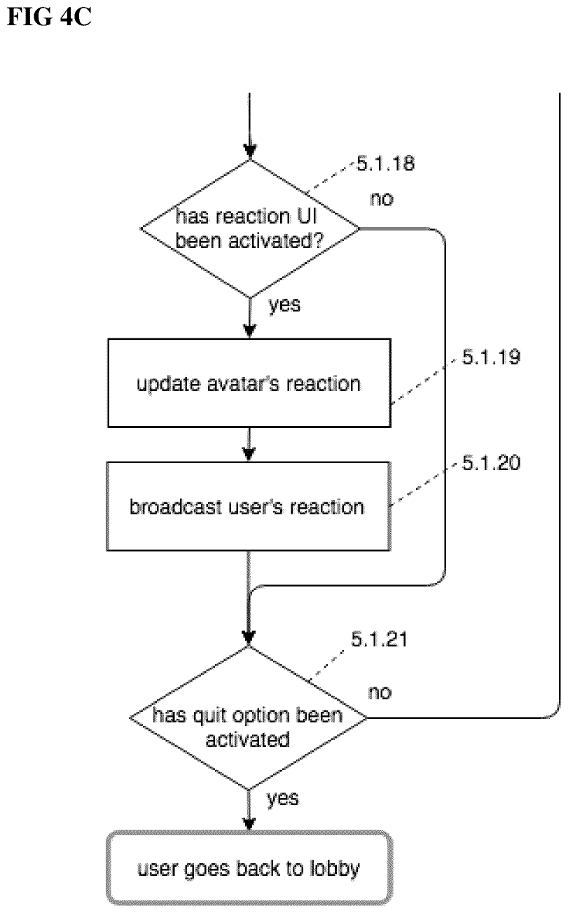

FIGS. 4A to 4C comprises flow charts illustrating in detail the software steps relating to the portion of the flow chart in FIG. 1 that relate to a user joining the performance as a spectator, rather than a performer. The user has the opportunity to join the performance as a spectator to view a pre-recorded performance or a live performance. This option is available from the lobby.

The user chooses their virtual ‘character’ and then is offered the opportunity to choose their ‘seat’ (5.1.5) in the viewing area. They are also given the opportunity to ‘emote’ their feelings about the performance using emojis.

### Acting Studio

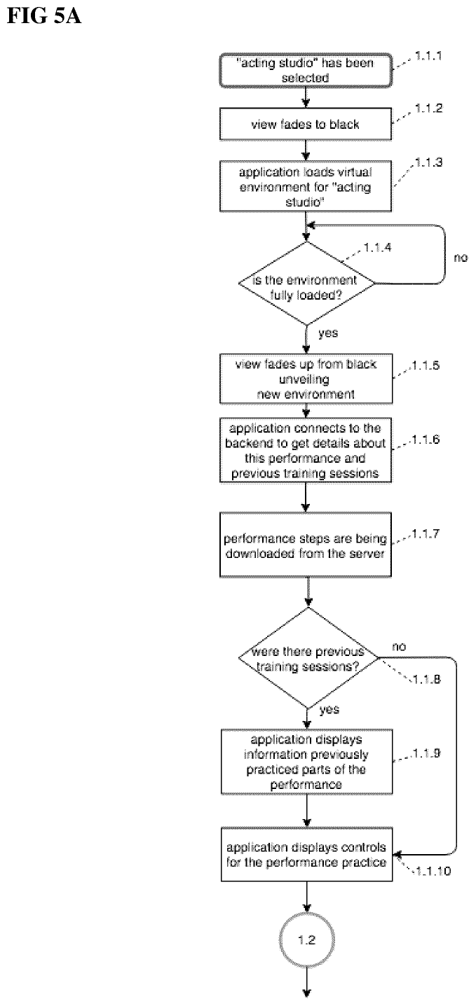

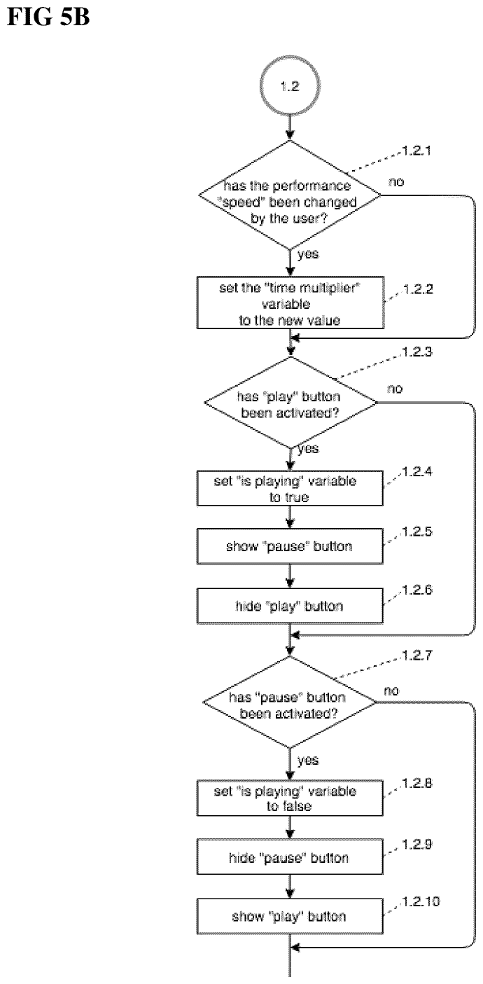

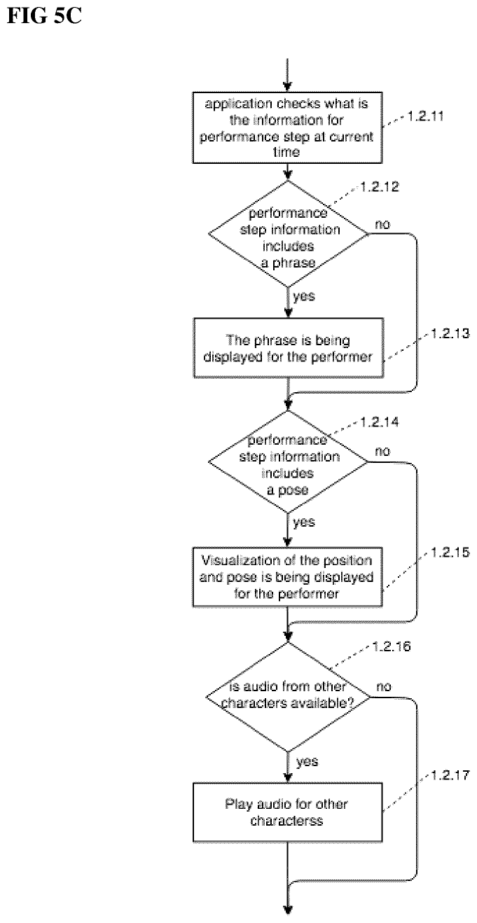

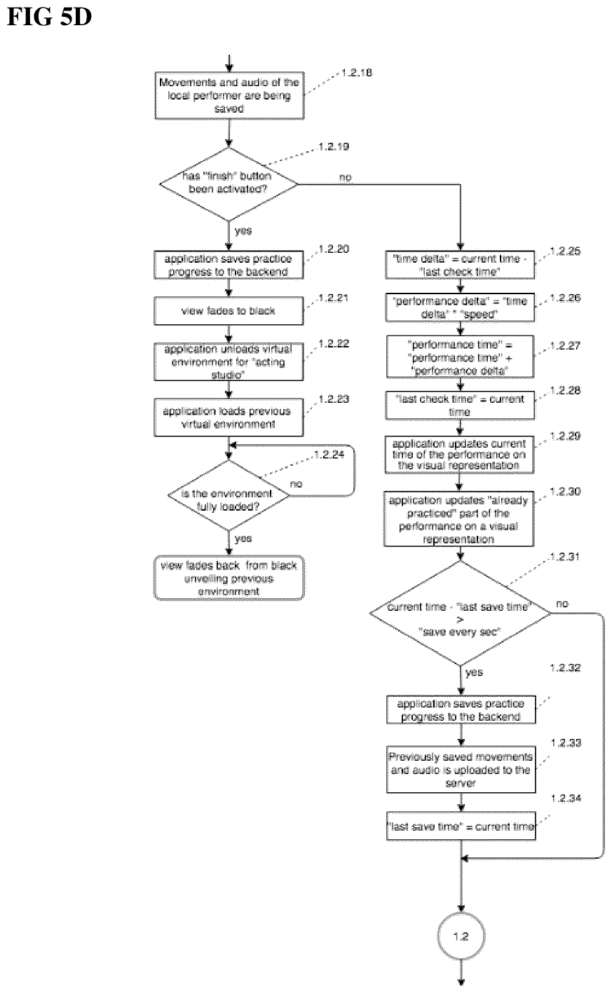

FIGS. 5A to 5D comprises flow charts illustrating in detail the software steps relating to the acting studio. The acting studio is a virtual environment where the user can practise any section of the musical that they wish. The user will have the ability to record themselves rehearsing and ‘scrub’ through their recorded performances to assess their own performance.

When the user first enters the acting studio, they have the option to either begin a new rehearsal or (if they have previously used the acting studio) review previously (pre-recorded) rehearsals. Application software will instruct the 3D engine to load the acting studio scene. (1.1.3) A 3D environment scene will have already been created in the 3D engine as part of a previous step. This will have been programmed in the 3D engine with logic functions including interactions or manipulations.

Audio and visual data relevant to the performance are downloaded. This includes information about words that should be spoken or sung at specific times and approximate poses that each performer should adopt at specific time (1.1.7). Saved data allows the playback of the performance. Saved data includes the pose of the character, the audio and facial expression (1.2.18).

Once they are happy with their rehearsal ‘performances’ the user will have the option to save these performances and export them to the lobby. These performances can be used later to ‘build’ contiguous performances leading to a complete rendition of the overall part of the complete musical. Upon entry to the acting studio, the performer can direct application software to instruct a 3D engine to upload a relevant scene of the musical (Box 1.3). The 3D scene will be selected from a library of 3D scenes for the musical that have previously been created in the 3D engine.

The performer can record themselves rehearsing the visual performance data and/or audio performance data. The performer is thus able to be immersed directly into the virtual story world environment in the first person perspective.

The performer can subsequently either re-record the performance data or review and optionally edit existing recorded performance data. The performer thus views and edits the performance from the third person perspective. The user's point of view (POV) can be optimised by creating an established camera angle and position within the navigable space that can be returned to by a one press action on a hand controller once the user moves too far, in distance, from the predetermined position to view the action. Once out of preferred viewing position, an icon appears in the virtual reality headset to remind the user that the action is not in their line of sight, allowing them to trigger a return to the preferred viewing angle and position instantaneously.

The dramatic ‘blocking’ or stage movement/action by digital performers is so constructed that either a single or alternative POV captures the detail of the scene without recourse to common cinematic conventions of close-up, extreme close-up and so forth. Compared to prior art filming of live-stream theatre productions, the actual placing of the viewer into the action space is immersive rather than being simply proposed as such in 2D video applications.

Performance with or without an Audience

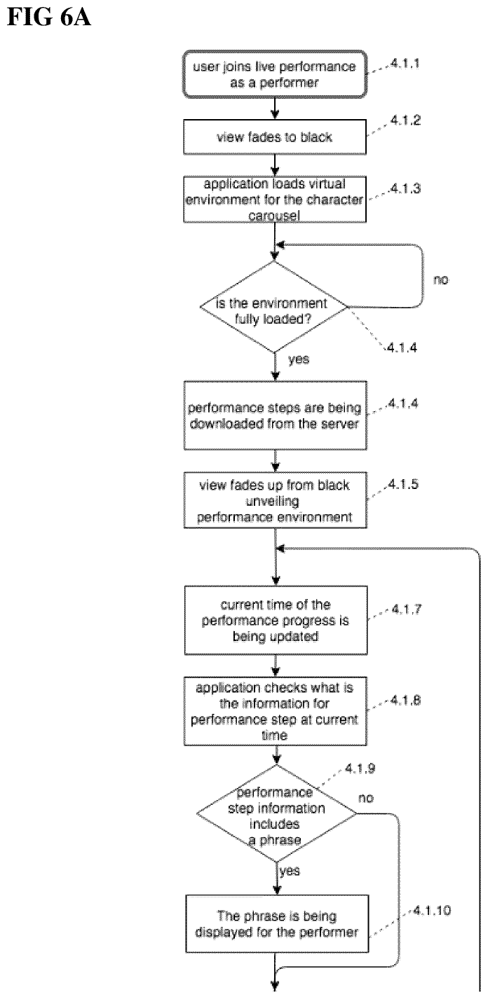

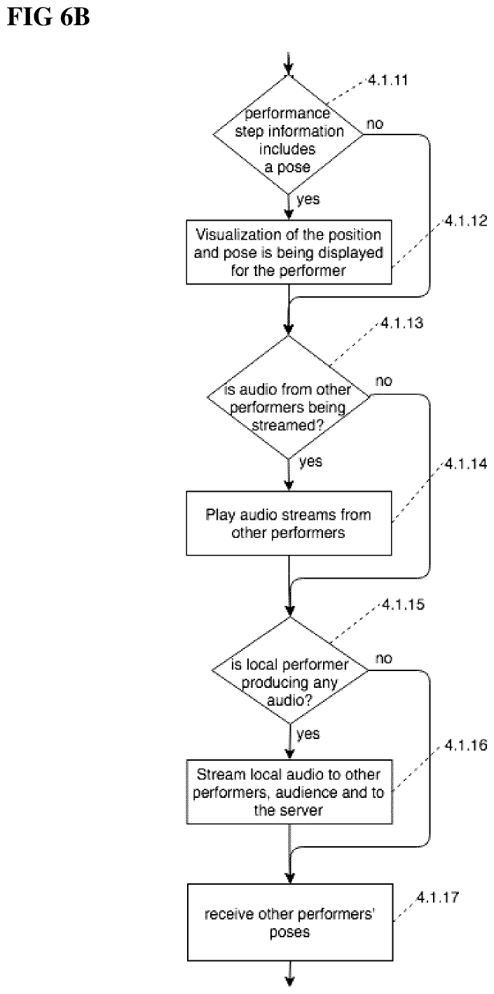

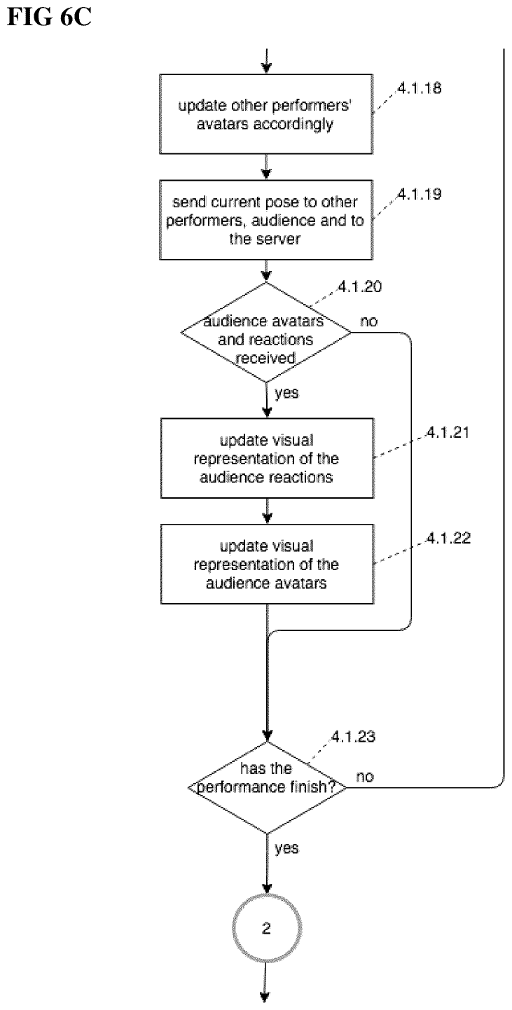

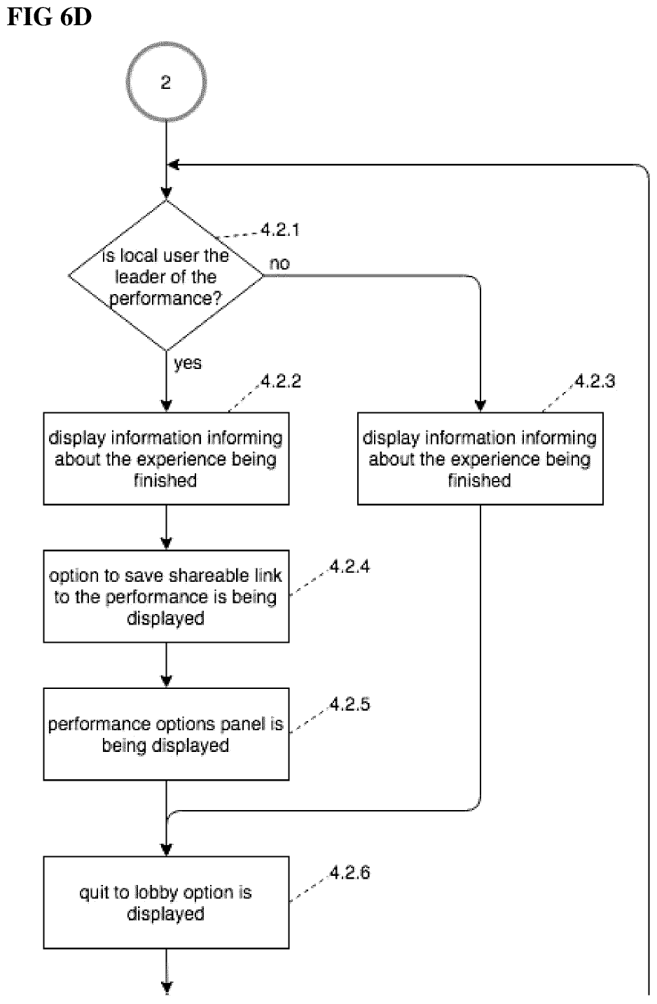

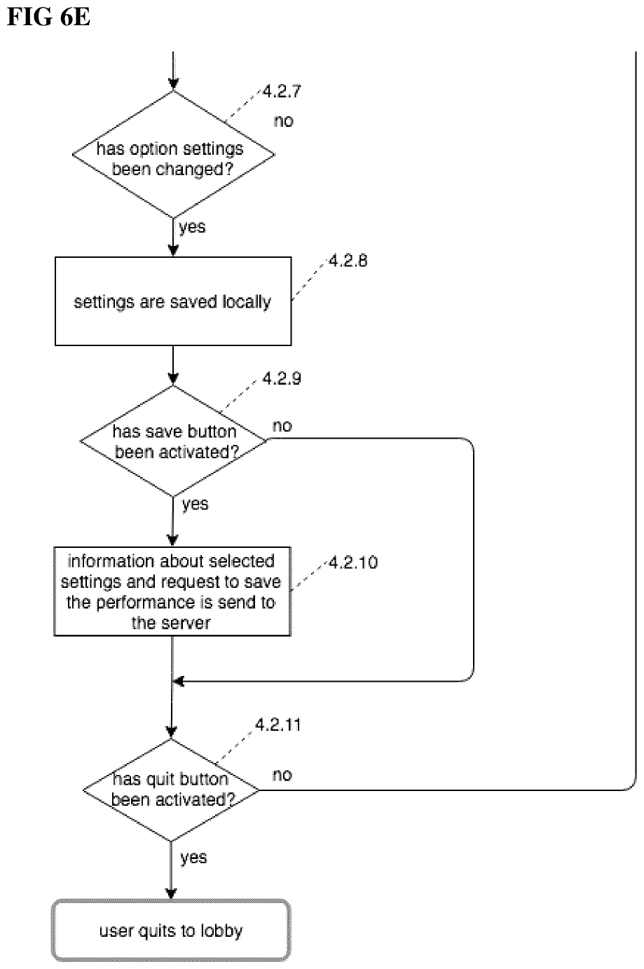

FIG. 6A to includes flow charts illustrating in detail the software steps relating to a user participating in the performance. The user has previously chosen their ‘character’ as described above. When it is the turn of the user to speak or sing the lines for their character will be displayed (4.1.9) at the current time. This is similar to a karaoke interface, displayed either in a specific UI or built into the environment. (4.1.10)

The user's blocking or choreography will be displayed in one of two different ways. They will either see a two dimensional ‘stage’ in the Heads Up Display (HUD) showing their upcoming movements. (4.1.4). Alternatively, the movements can be shown as a semi-transparent ‘ghost’ that performs the correct choreography and blocking that the user can attempt to match as closely as possible. In this manner it is possible to make provision within the virtual reality environment for the user to monitor the audience and their movements, that is, the user, not the computer, has the capacity to observe the reactions of audience's movements whilst monitoring the performance, i.e., bi-directional human interaction/communication with the computer acting only as the conduit.

The user can hear and see the other users' performances in real time via the server. After the performance, a user designated as a ‘Leader’ of the performance can choose whether to save the performance and whether to make it publicly viewable. Each tick/frame takes specific amount of time. The “current time” is increased by that time on each frame/tick. (4.1.7)

A pose and position may be included in the performance step information. (4.1.11). This describes where the performer should be on stage at this time and what should be their pose. This could be displayed as semitransparent “ghost” that the performer should align with or foot marks indicating where the performer should stand (4.1.12).

The user can also receive information about other performers poses as skeleton data or points cloud information, or some other solution that depicts the character position and pose (4.1.17). A performance options panel (4.2.5) includes settings allowing the performance to be either public and searchable or private for selected viewers. It also allows for change if the performance can be altered in addition to other settings.

### Example—Virtual Reality Components for a Musical Play

In this embodiment of the present invention the user moves through a virtual reality environment within the performance framework of a musical play, in a first-person perspective. The user moves between plot points in the story associated with the musical as the narrative unfolds linearly.

According to the present invention, if the user is a performer, they may add audio data or visual data, or substitute it for audio data or visual data they previously recorded in the virtual reality environment. In all such instances, regardless of the number of performers inhabiting character roles within the musical play, the avatar corresponding to each performer remains visible to all other performers, but not to the person performing the respective character role, that is, the performer becomes the embodiment of the character avatar.

Typically, the user experiences the musical play either through a VR headset, navigating using the VR controllers, or on a Mac or PC, navigating using keyboard or mouse, or using a mobile phone (IOS or Android), where navigation is fixed and the musical is experienced as a 360° ‘video’. The user may look around but not be able to independently travel through-out the world.

The virtual reality environment may be delivered by high quality audio playback, mix and implementation, typically run on any suitable VR headsets and PC or Mac as a downloadable experience. The VR headsets could for example run the Oculus Quest hardware system. In one embodiment a downloadable iOS and Android version could be created for viewing on mobile devices. If high quality audio is required, the virtual reality experience would typically be delivered as a downloadable experience to avoid degradation of audio quality due to over compression.

The performance component may include pre-defined audio data and visual data embodying the following:
(a) songs sung by animated characters—the full body and facial movement created using mocap technology or similar,
(b) dialogue delivered in narrative scenes by the characters either by:
   (i) voiceover accompanying animated gestures,
   (ii) 360° Video of actors performing the scenes, or
   (iii) 2D Video integrated into the VR environment as pop-up or 3D screen.

Typically, during narrative scenes where character movement is less pronounced, animation sequences (rather than mocap) may be used for characters composited from movement animation libraries. If the performance framework is for a play or other dramatic performance, it may include a story taking place in different virtual locations in with various interior and exterior environments. These would be embodied in visual data.

If the performance framework includes performance components such as an orchestra or actors, their performance components could be captured as pre-recorded video and audio data using 360° video capture. This would allow a user during immersion in the virtual reality experience to choose to view the environment from different camera positions. For example, during a song the user could choose to view “Cinematic Version” (comprising preset camera locations) or remain in “Performer View” where the performer can continue to free roam, for example to different virtual locations in a story.

The user may choose to replace pre-recorded data with their own performance data created during immersion in the virtual reality experience. For example, the performer may choose the option of ‘Sing-a-long’ at the start of the experience. This mutes the pre-recorded audio data (singing) for a character, so that the performer can replace it with their own audio data.

When two or more users participate as performers in the same virtual reality experience, each may participate as a different character and create their own audio data. If the performers VR headsets are connected to the same server, they may create a real-time sing-a-long experience. In all such instances, regardless of the number of performers inhabiting character roles within the musical play, the avatar corresponding to each performer remains visible to all other performers, but not to the person performing the respective character role, that is, the performer becomes the embodiment of the character avatar.

The performance elements are not limited to artistic pursuits such as singing or dialogue and may include more physical or athletic performances such as horse racing or boxing. For example, it would be possible to include within the performance framework, a performance element such as a horse race. Performers could take on avatars characterised as jockeys and use VR hand controllers to move the reins to steer the horse. The race performance would have a result constrained by the performance framework but chosen from a limited number of options.

Similarly, for boxing the performers could take on avatars characterised as boxers and use VR hand controllers as boxing gloves. The race performance would have a result constrained by the performance framework but chosen from a limited number of options.

While this invention has been described in connection with specific embodiments thereof, it will be understood that it is capable of further modification. This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above-described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; GraphQL; Golang; HTML; Icon; Jason; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Typescript; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term “comprising” is intended to encompass the narrower “consisting essentially of” and the even narrower “consisting of.” Thus, in any recitation herein of a phrase “comprising one or more claim element” (e.g., “comprising A), the phrase is intended to encompass the narrower, for example, “consisting essentially of A” and “consisting of A” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

1. A virtual reality system for a virtual performance, including comprising:
an immersive virtual reality environment defined by a performance framework and comprising pre-defined visual data and pre-defined audio data, and
at least one user input device and at least one user output device for a user in electronic communication with the immersive virtual reality environment,
wherein the user interacts with the immersive virtual reality environment to insert into the system, user visual data or user audio data created within the performance framework by the user during immersion in the virtual reality environment.

2. A virtual reality system according to claim 1 wherein the performance framework includes multiple sub-frameworks that comprise user visual data or user audio data.

3. A virtual reality system according to claim 1 wherein the user visual data or user audio data created by the user during immersion in the virtual reality environment is inserted into a database accessible by software that runs the virtual reality system.

4. A virtual reality system according to claim 3 wherein the inserted user visual data or user audio data adds data to the database.

5. A virtual reality system according to claim 3 wherein the inserted user visual data or user audio data replaces at least some of the data in the database.

6. A virtual reality system according to claim 1 which is adapted for interaction with two or more users subsequently or simultaneously in respect of an immersive virtual reality environment defined by a performance framework.

7. A virtual reality system according to claim 1 wherein the performance framework comprises a gaming component.

8. A virtual reality system according to claim 1, the system further comprising:
at least one processing device;
at least one system database;
a network;
the network connecting the processing device and the user input device and the user output device in electronic communication.

9. A method for interaction between a user and an immersive virtual reality environment, the method comprising:
providing an immersive virtual reality environment defined by a performance framework and comprising pre-recorded visual data and pre-recorded audio data relating to performance components, and
providing at least one user input device and at least one user output device in electronic communication with the immersive virtual reality environment,
the user communicating with the immersive virtual reality environment to insert visual performance data or pre-recorded audio performance data created by the user, during immersion in the virtual reality environment.

10. A method for interaction between a user and an immersive virtual reality environment according to claim 9 which further comprises the step of inserting the user visual data or user audio data into a database accessible to software that runs the virtual reality system.

11. A method for interaction between a user and an immersive virtual reality environment according to claim 10 wherein the inserted user visual data or user audio data adds data to the database.

12. A method for interaction between a user and an immersive virtual reality environment according to claim 10 wherein the inserted user visual data or user audio data replaces at least some of the data in the database.

13. A method for interaction between a user and an immersive virtual reality environment according to claim 10 when used by two or more users subsequently or simultaneously in respect of an immersive virtual reality environment defined by a performance framework.

14. A system or method according to claim 9 wherein the performance framework comprises one or more of a dramatic play, musical play, dance routine, choral piece, concert or ceremony.

15. A non-transitory computer readable storage medium having a computer program stored therein, wherein the program, when executed by a processor of a computer, causes the computer to execute the method steps according to claim 9 for interaction between a user and an immersive virtual reality environment.

16. An application stored on a non-transitory medium adapted to functionally enable the application comprising a predetermined instruction set adapted to enable the method steps according to claim 9 for interaction between a performer and an immersive virtual reality environment.
